(19) United States
(12) Patent Application Publication
(10) Pub. No.: US 2019/0310464 A1
(43) Pub. Date: Oct. 10, 2019

(54) IMAGE GENERATION DEVICE

(71) Applicant: Fraunhofer-Gesellschaft zur Förderung der angewandten Forschung e.V., München (DE)

(72) Inventors: Joachim Janes, Itzehoe (DE); Thorsten Giese, Hohenaspe (DE)

(21) Appl. No.: 16/348,362

(22) PCT Filed: Nov. 9, 2017
(86) PCT No.: PCT/EP2017/078741

§ 371 Date: May 8, 2019

(30) Foreign Application Priority Data
Nov. 9, 2016 (DE) 10 2016 221 933.2
Dec. 23, 2016 (DE) 10 2016 226 212.2

(51) Int. Cl. G02B 26/10; G02B 26/08; G01J 3/02; G01J 3/42; G01N 21/64; G01J 3/44

(52) U.S. Cl. CPC G02B 26/101; G02B 26/0833; G01J 3/0208; G01J 3/021; G01J 3/42; G01N 21/6456; G01N 2201/1053; G01J 2003/421; G01N 2021/6463; G01N 2021/6417; G01N 2201/06113; G01N 2201/0636; G01N 2201/0633; G01J 3/4406

(57) ABSTRACT

The invention relates to an image generation device comprising a laser light source (1); a mirror assembly having two parabolic mirrors (3, 6) via which a scanning light beam (1a, 5) generated by the laser light source is directed onto a sample surface (9); a deflection device (2), in particular a micromirror scanner, which is controllable such that the scanning light beam (1a, 5) scans points of the sample surface in a targeted manner; and a detector (10) which detects radiation emanating from a scanned point of the sample surface. The spatial resolution of the image generation device is substantially defined by the narrowest possible focusing of the laser beam, and the accuracy of the adjustable deflection angle is defined by the micromirror scanner.

The invention resides in the field of optics and electromechanics and can be used particularly advantageously for analytical methods. Particular advantages arise in the use for examination methods of optical spectroscopy.

Modern analytical methods are undergoing continual optimization in various directions, attempts being made, on the one hand, to miniaturize analytical devices and, on the other hand, to optimize measuring accuracy levels and the resolution. A preferred optical detection method is UV absorption detection or UV-excited fluorescence spectroscopy. This can be used, in particular, within the scope of epifluorescence configurations. Advantageously, it is possible to use, as radiation sources, not only UV sources in fluorescence analytics which make it possible to induce natural fluorescence in a large number of biological molecules, in particular proteins containing tryptophan or tyrosine.

The known UV fluorescence detection technique, at wavelengths of 266 nm, for example, requires complex epifluorescence configurations. Optical components such as objectives, filters and condensers must have a high transmission for UV radiation and low autofluorescence at the excitation wavelength to achieve the desired efficiency of the measurement.

It is the object of the present invention to create an optical detection device for fluorescence spectroscopy examinations which is able to detect fluorescent radiation efficiently and with high spatial resolution.

The object is achieved according to the invention by an image generation device having the features of claim 1. Claims 2 to 11 relate to specific embodiments of the invention.

Accordingly, the invention relates to an image generation device, comprising a laser light source, a mirror array including two parabolic mirrors, via which a scanning light beam generated by the laser light source is directed onto a sample surface, a deflection device, in particular a micromirror scanner, which can be controlled in such a way that the scanning light beam scans points of the sample surface in a targeted manner, and a detector, which detects radiation emanating from a scanned point of the sample surface.

Using two parabolic mirrors, it is possible to construct an optical imaging device for a light beam, which is able to implement a magnification, a diminution or a 1:1 depiction based on the geometric parameters of the mirrors, the positions thereof and the distance between one another. A laser beam that passes the two parabolic mirrors, that is, is consecutively reflected at the two parabolic mirrors, can be set/focused so as to illuminate a very small, very sharply delimited spot in a plane behind the mirrors in which the sample can be placed, so that the plane can be placed behind the mirror. If the laser beam is deflected prior to being reflected at the parabolic mirrors, a reduction or an increase in the diversion movement of the laser beam arises behind the parabolic mirrors, depending on a settable magnification or diminution scale. From this, it follows that the laser beam, in the region prior to passing the parabolic mirrors, can be deflected in a targeted manner by a deflection device, for example a micromirror scanner, and that this deflection can be increased or reduced by the parabolic mirror system.

A detector, which detects radiation, can be directed at the plane illuminated by the laser beam and detect the radiation reflected from a sample on the illumination plane at the respective spot illuminated by the laser. In this way, it is possible to scan a surface area with very high resolution in the illumination plane, if the micromirror scanner allows a diversion of the laser beam in multiple planes. The information as to which image point is illuminated by the laser beam at a particular point in time is available in the control unit of the deflection device/of the micromirror scanner. An intensity of the radiation reflected by the sample on this point, as recorded by the detector, can be assigned to the respective illuminated point. From this, it is possible to obtain a two-dimensional image of the sample, for example in highly magnified form. The optical resolution of the image generation device is only limited by the accuracy of the control of the scanner on the one hand, and by the diameter of the laser beam in the focal point thereof on the image plane/on the surface of the sample on the other hand.

According to this concept, no lenses or condensers refracting visible or UV light are needed, which require a certain size as a mandatory factor, and ideally are not transparent, that is, also lower the radiant intensity, and generate image distortions.

An advantageous embodiment of the invention provides that the deflection device comprises a 2D MEMS scanner. Such mirror systems are also referred to as micro-opto-electro-mechanical systems (MOEMS) scanners and in many instances comprise a mirror that can be deflected in a targeted manner in a pivoting movement about two different axes by way of a drive. A laser beam incident upon the micromirror is diverted in an accordingly controlled manner. By controlling the diversion in two independent directions, it is possible for the reflected laser beam to completely scan a solid angle. In the sample plane, this solid angle corresponds to a fully scannable image area.

Another advantageous embodiment provides that the deflection device comprises an angle setting element. Such an angle setting element can be operated piezoelectrically, for example, or it may be a statically, for example a quasi-statically, operated microscanner. The setting element deflects the laser beam and maintains a position for a long period of time, such as several seconds. In this way, a very fine spot is illuminated on the illumination plane for a longer period of time. This kind of deflection device is used, among other things, so as to be able to carry out absorption spectroscopy or excitation spectroscopy in this way in a location of the sample for identifying the sample material or sample properties, or so as to detect the chemical signature thereof.

A method according to the invention for operating the image generation device can accordingly provide that the scanning light beam, prior to or after scanning of the sample surface, is directed onto a sub-area of the sample surface in a static setting of the deflection device and, in this setting, a spectroscopic examination of the radiation emitted by the sub-area is carried out.

Since the angular position of the mirror in both axes can be established very precisely during the control/regulation of the deflection angles of such a MEMS system, it is also possible to assign a point in the image plane very precisely to each mirror position, to which a light beam/laser beam is diverted with the appropriate position of the mirror. In this way, the detector is able to detect and store the intensity of the reflected radiation, or of fluorescent radiation triggered as a consequence of the primary illumination, for each point of the sample surface, provided it is illuminated by the diverted beam. With this, a spatially resolved depiction of the image plane with respect to the intensity distribution of the detected radiation is generated. The resolution of this depiction is only limited by the accuracy of the activation of the deflection device and the size of the laser spot in the image plane.

Drive mechanisms for a MEMS scanner include, for example, electromagnetic, electrostatic, piezoelectric or thermoelectric drives. For example, the mirror can be produced using known technologies, such as are disclosed in DE 102006058563, for example. As a result, the deflection of the mirror at a given force can be optimally reproduced, and thus it is also possible to optimally determine the point in the image plane onto which the laser beam is diverted under a given force action.

The mirror drive can also be provided with a regulating unit, which sets the angle of the mirror.

In one embodiment, it may be provided, for example, that the deflection device is arranged in the focal point of the first parabolic mirror passed first by the scanning light beam, or in the immediate vicinity thereof, for example situated less than 5 mm away therefrom. This arrangement of the mirror, or more precisely the intersecting point of the two axes about which the mirror can be rotated, causes the light beams that reach the mirror there, in the focal point of the parabolic mirror, and which are diverted by the same in the direction of the parabolic mirror, in any case to exit parallel to one another and, with an appropriate setting, also parallel to the axis of symmetry of the parabolic mirror, independently from the direction of incidence upon the deflection mirror, after reflection at the parabolic mirror. This means that this laser beam is incident upon the parabolic mirror, starting from the focal point, at varying angles of incidence during a diversion of the laser beam by the mirror, but is displaced in each case parallel to the axis of symmetry of the mirror. An arbitrary deflection angle or diversion angle of the scanning device is thus translated into a parallel offset of the beam.

It may further be provided that the sample surface is arranged in the focal point of the second parabolic mirror or in the immediate vicinity thereof, in particular between 1 mm and 5 mm in front of or behind the focal point, seen in the direction of the scanning light beam, wherein the scanning light beam passes the second parabolic mirror after the first parabolic mirror. The light beams that, after passing the first parabolic mirror, pass the second parabolic mirror and are reflected thereat are focused in the focal plane thereof in a focal point, that is, all laser beams that are parallel incident are concentrated on a focal point. The angular diversion prior to incidence upon the first parabolic mirror after the second parabolic mirror is translated into an output-side angular diversion. By suitably selecting the parameters of the two parabolic mirrors, it is thus possible to reduce the diversion angle whereby, during scanning in the image plane, a higher absolute resolution that is based on absolute distances in the image plane is created than with the diversion in front of the first parabolic mirror.

It may further advantageously be provided that the axes of symmetry of the first and second parabolic mirrors extend parallel to one another, and in particular are congruent. In this way, a symmetry of the entire configuration is achieved, which minimizes aberrations and makes the configuration particularly space-saving.

It may further be provided that the detector comprises a sensor for radiation detection, which detects a surface-integral radiant intensity and, in particular, comprises only a single radiation-sensitive semiconductor element.

The spatial resolution of the detector plays only a minor role for the spatial resolution of the measurement. The detector detects the radiation reflected at the illuminated, and ideally very small, point of the image area. Here, only the detection of an overall intensity matters. The sensor can be selected to be very sensitive, for example in the form of an avalanche diode.

A further embodiment can provide that the two parabolic mirrors have the same shape and size. Such a configuration of the parabolic mirrors yields a 1:1 depiction. Even without magnification, a high spatial resolution can be achieved by accordingly good focusing of a laser on a very small point in the image plane.

If the parabolic constant of the second parabolic mirror is greater than that of the first, it is possible to achieve magnification that, combined with good focusing of the laser beam, allows a further improved spatial resolution to be achieved when scanning a sample.

Good focusing of the laser beam that illuminates the sample can be achieved by selecting a suitable beam shaping lens system. The radii of curvature of the two parabolic mirrors also have an influence and can be optimized accordingly in the selection of the configuration. The light reflected or scattered by the sample, or the fluorescent light generated by the illumination with the laser beam, is detected by the detector. For example, the diameter of the laser beam in the image plane (the object plane in which the sample is located) can be 1 μm, whereby it is achieved that the sample can be sampled using a resolution of 1 μm. The surface area of the sample can be achieved by scanning of an angular range with two independent diversion angles of 40°, for example, with appropriate magnification.

The distance between the sample and the focal point of the second parabolic mirror is also crucial for the determination of a magnification factor. So as to set the magnification, it may thus be provided that the distance between the sample surface and the focal point of the second parabolic mirror can be set. For it to be possible to correctly and precisely associate the intensity of the reflected/scattered or fluorescent light from the sample with the respective point illuminated by the laser beam, it can further be provided that the laser light source and the deflection angles of the deflection device, and in particular the angles of inclination of a 2D MEMS scanner, can be controlled by a shared device (control unit) in such a way that defined points of the sample surface are irradiated at definable points in time, and a radiant intensity emanating from the point which is detected by the detector is assigned to each irradiated point.

The invention will be shown and described hereafter based on exemplary embodiments in figures of a drawing. In the drawings:

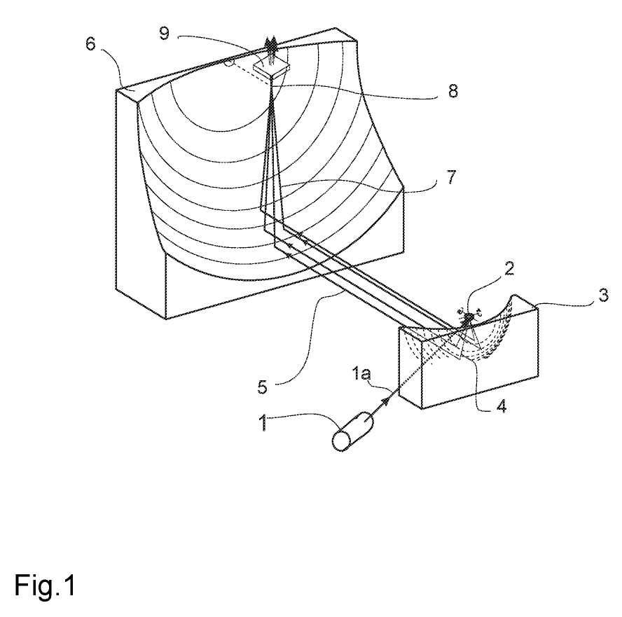

FIG. 1 shows an image generation device comprising two parabolic mirrors and a micromirror scanner;

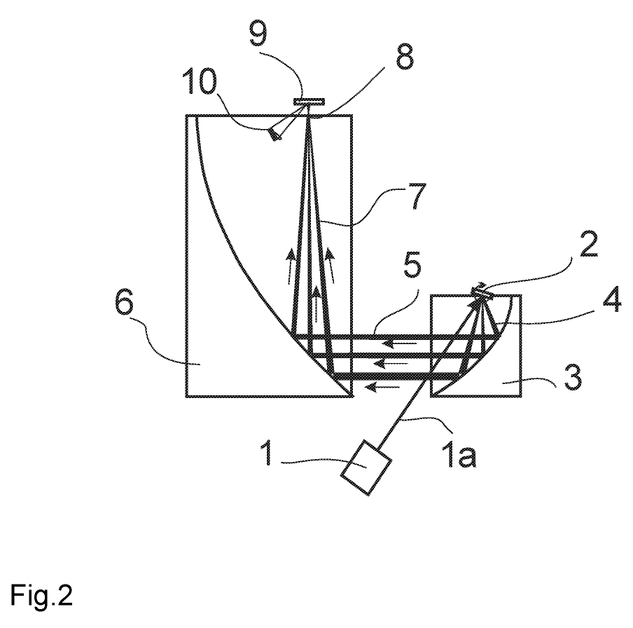

FIG. 2 schematically shows the progression of a beam in the case of an array comprising two parabolic mirrors;

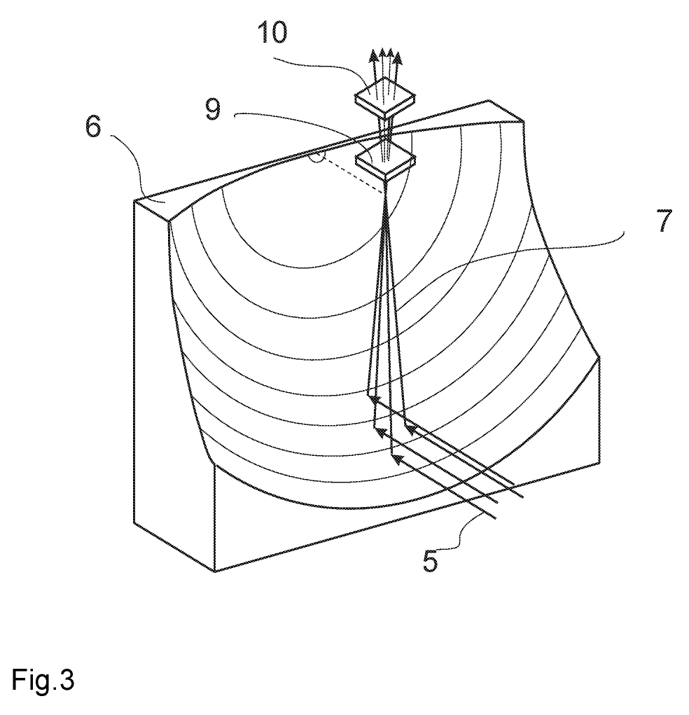

FIG. 3 shows the second parabolic mirror with the focal plane thereof and a sample plane;

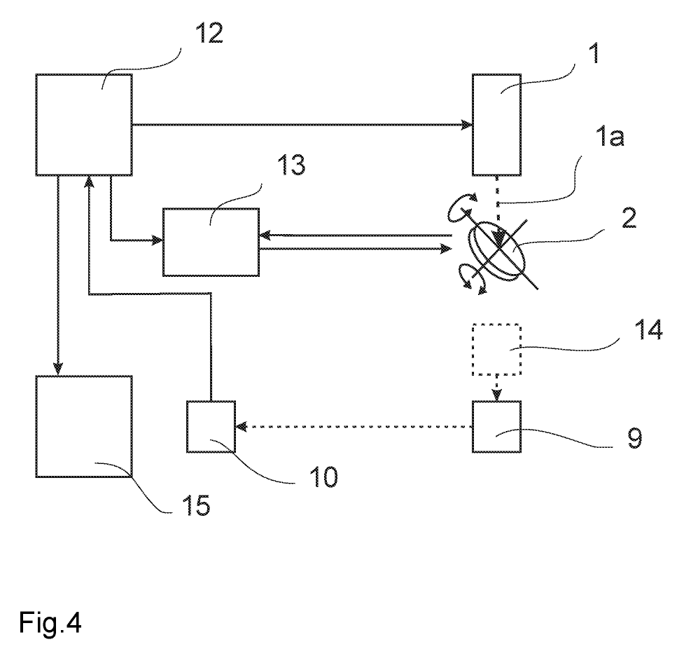

FIG. 4 shows the schematic configuration of a control of the system; and

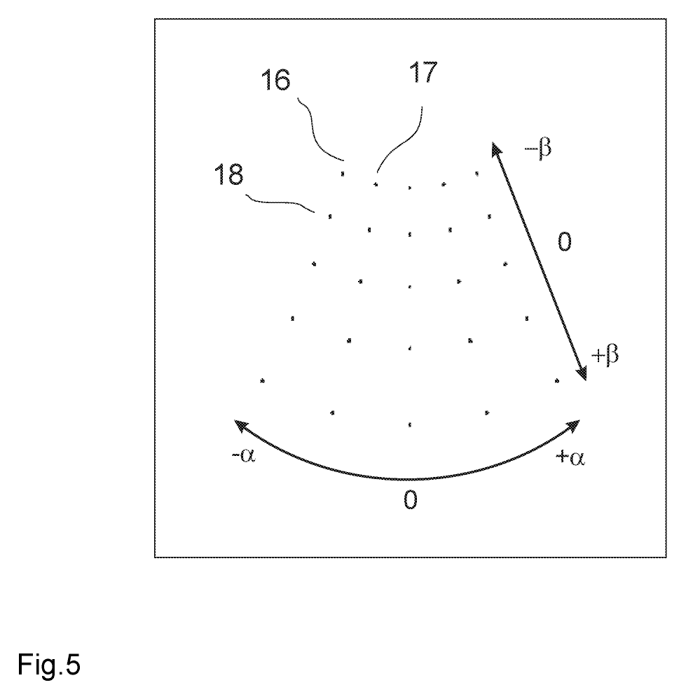

FIG. 5 shows an example of the diversion directions of the laser beam in the image/sample plane.

FIG. 1 shows a configuration comprising a laser light source 1, two parabolic mirrors 3, 6 and a 2D microscanner 2. The laser beam 1a is directed from the laser source onto the microscanner 2, from there onto the first parabolic mirror 3, and from there via the second parabolic mirror 6 to a sample 9 in a sample plane, which can also be referred to as an object plane.

A laser emitting in the ultraviolet light range can be used as the laser light source, for example. The ultraviolet laser beam 1a then passes over a surface region on the sample 9 in the object plane by way of a micromirror of the microscanner 2 being deflected.

As a result of an appropriate increase/reduction in the beam deflection of the laser beam 1a through the selection of the appropriate parameters of the parabolic mirrors 3, 6, a surface region of the sample can be scanned with very high spatial resolution in the object plane by an accordingly strongly concentrated laser beam.

The light reflected by each individual scan point, for example also fluorescent light, can be detected by a detector, which is not shown in FIG. 1. In this way, a complete image of the scanned region on the sample 9 can be obtained.

The design and the drive of the 2D microscanner can be of a commercially available type; for example, a mirror of the microscanner can be driven electromagnetically, electrostatically, piezoelectrically or in another manner. However, it is important that the deflection angle, that is, the setting angle of the micromirror, can be set precisely or is measured precisely. For this purpose, a corresponding regulating unit can be provided in the scanner, in which the mirror position is reported back to the control unit. Since the 2D microscanner in the shown exemplary embodiment is located in the focal point of the first parabolic mirror 3, the light beams/laser beams reflected from there to the mirror 3 are translated into parallel beams, the bundle of rays generated consecutively being denoted by reference numeral 5 in FIG. 1. The beams shown there, extending parallel to one another, usually do not exist simultaneously, but represent beams reflected consecutively by the microscanner at varying angular positions.

These beams are irradiated into the second parabolic mirror 6 parallel to the axis of symmetry thereof in the configuration shown in FIG. 1, and concentrated on the focal point of the second parabolic mirror 6 according to the laws of geometrical optics. Laser beams diverted by the microscanner 2 at varying angles reach the focal point 8 of the mirror in the region of the second parabolic mirror 6 at varying angles. Different beams will thus reach the focal point 8 in the second parabolic mirror at varying angles.

The sample 9 is arranged in an object plane behind or in front of the focal point 8, so that the light beams incident at varying angles reach the sample at different points thereof. As a result, certain angular diversions of the 2D microscanner are translated into lesser angular diversions of the beam in the region of the second parabolic mirror 6 with appropriate parameterization of the parabolic mirrors 3, 6. In this way, the sample 9 can be scanned with very high spatial resolution when the condition is met that the laser beam 1a is optimally concentrated, so that the cross-sectional surface area of the laser beam is minimized in the region of the object plane.

In the shown exemplary embodiment, the parabolic constant of the second parabolic mirror 6 is greater than that of the first parabolic mirror 3. This results in a determined translation factor of the magnification or of the spatial resolution on the sample.

In addition, the distance between the sample 9 or the object plane and the focal point 8 can be settable so as to be able to adapt the conditions on the sample 9 to the achievable angular resolution of the microscanner and the achievable optimized concentration of the laser beam 1a.

For concentrating the laser beam 1a, a beam shaping lens system can be provided in the region between the laser light source 1 and the 2D microscanner so as to be able to optimize the concentration of the laser beam.

In practice, the absolute distance between the sample 9 and the focal point of the second parabolic mirror 6 will only be a few millimeters. If the diameter of the laser beam in the object plane is 1 μm, for example, the sample can be detected using 1000×1000 scanning points located next to one another, which cover a sample surface of 1 mm². This surface can be scanned, for example, by an angular deflection range of the 2D microscanner of 40° in two planes perpendicular to one another. The magnification of the image generation device can be determined by the distance between the object plane and the focal point 8 of the second parabolic mirror, without having to adapt optical elements.

FIG. 2 schematically shows the progression of the beams again in a non-perspective illustration. Identical components are denoted by the same reference numerals in FIG. 2 as in FIG. 1. The parabolic mirrors 3, 6 shown only schematically.

It is also apparent from FIG. 2 that the fluorescent light reflected from the sample 9 is detected by a detector 10, which comprises an avalanche diode, for example. At any point in time, the detector, if there is no interference from ambient light, can be directed onto the sample 9 without any particular spatial resolution since it is established, at any given point in time, what location on the sample is being illuminated by the laser beam, so that the reflected light intensity can be sure to stem from the recorded sample surface point. This condition, however, is only readily met when the light detected by the detector is fluorescent light, having a wavelength different from that of the irradiated light/of the irradiated UV radiation, so that the fluorescent light can be filtered out. The consecutively measured intensity values are stored and, in a processing unit, assigned to the different activated sample surface points, whereby a two-dimensional image of the sample surface is created.

FIG. 3, in greater detail, again shows the effect of the image magnification, wherein in addition to the sample 9 in the first object plane, a second position 11 of the sample at a greater distance from the focal point 8 is shown. If the sample is placed in a second object plane 11, a lesser magnification results than in the position denoted by reference numeral 9.

In the configuration shown in FIGS. 1 to 3, the parabolic mirrors 3, 6 are arranged in such a way that the axes of symmetry thereof extend parallel to one another. The axes of symmetry can also be congruent, for example. However, they may also extend at an angle with respect to one another.

FIG. 4 schematically shows a control system for the image generation device. The control system provides a control unit 12, which controls the laser light source 1 on the one hand and, by way of a downstream controller 13, a MEMS microscanner 2 on the other hand. The laser light source 1 can be pulsed in such a way, for example, that laser beams are only incident upon the mirror of the MEMS scanner when the respective desired deflection angle is set. In this way, laser power can be saved, and the heating of the device, and in particular of the laser light source and the sample, can be reduced.

As is shown in a dotted fashion in FIG. 4, the laser light 1a is incident upon the MEMS microscanner and is deflected onto a point of the sample in accordance with the set deflection angle. As a result of the system of parabolic mirrors, which is to be represented in dotted fashion by the box 14, multiple reflections take place until the sample 9. There, the laser beam 1a reaching the sample causes the reflection or back scattering or emission of fluorescent light at the target point, which is recorded in a detector 10. The detector 10 can be covered by a filter, which only allows the wavelength range to be detected, in particular in the UV range, to pass. The light intensity is recorded in the detector 10 and forwarded to the control unit 12. The coordinates of the instantaneous position of the microscanner and/or accordingly the activated sample surface point and the reflection intensity or detection intensity of light by the detector 10 are combined in the control unit 12 and passed on to a memory and representation unit 15, where the pieces of information are assembled to form an image of the sample and stored. The image can then be displayed to the user and/or also be automatically evaluated.

FIG. 5, by way of example, shows how an angular deflection on the 2D microscanner, which is composed of two diversion angles there in mutually perpendicular axes, is translated into corresponding diversion directions of the laser beam in the object plane. The different reflections of the light beam by the parabolic mirrors and eccentric positions of the scanner and/or of the sample cause corresponding distortions. However, it is important that a two-dimensional surface area on the sample can be passed over due to the angular diversions in combination with one another, which is represented in FIG. 5 by the distributed points 16, 17, 18.

One advantage of the invention compared to other scanning methods and devices is the use of a single 2D MEMS scanner (2) for diverting the laser beam (1a). This enables a compact design of the device. Preferably, the laser beam (1a) is irradiated perpendicularly to the surface of the deflection mirror in the one oscillation direction of the 2D MEMS scanner (2), and at an angle of incidence of more than 22.5°, in particular between 22.5° and 30°, further in particular between 22.5° and 25°, based on the pivot point, in the other oscillation direction. This enables a maximum, overall solid angle range scannable by the laser beam (1a), of almost +/−90° spanned in the one scanning direction and of almost +/−45° spanned in the other direction.

Preferably, the two half shells (3) and (6), having surfaces that are designed as parabolic concave mirrors, are positioned at a distance between 1 cm and 2 cm from one another. In this way, it is ensured that the laser beam (1a) reaches the 2D MEMS scanner (2) without impairment at an angle of incidence of at least 22.5°. It is advantageous to keep the distance between the two parabolic mirrors (3) and (6) as small as possible, in particular smaller than 3 cm, and further in particular smaller than 2 cm, so as to minimize alignment inaccuracies in the positioning of the two concave mirrors (3) and (6) with respect to one another.

In principle, it is up to the individual configuration at what angle the sub-beams (7) intersect the axis of symmetry of the concave mirror (6). Preferably, the central beam of the sub-beams (7) should intersect the axis of symmetry at an angle between 80° and 100°, and more preferably of 90°. A central beam shall be understood to mean the sub-beam (7) that results from averaging between the outermost angular positions of the 2D MEMS scanner (2) from 0° in the two scanning directions. Under this prerequisite, the diameters of the sub-beams (7) are essentially identical in size after the reflection and in the plane (9) located between 1 mm and 5 mm beyond the focal point (8) of the parabolic mirror (6).

In addition, it may be advantageous that the surface normal of the object plane (9) is oriented parallel to the direction of the central beam of the sub-beams (7). Under this prerequisite, first, the diameters of the sub-beams (7) are almost identical in size and secondly, an almost homogeneous illumination density of an object located in the object plane (9) is achieved.

Scattered light and/or fluorescent light is created in each point in the object plane (9) illuminated by a laser beam. This scattered light or fluorescent light has a radiation characteristic that depends on the surface properties of the object in the object plane (9). For a large number of applications, it is possible to approach the radiation characteristic of an illuminated point in the object plane using a cosine distribution. This cosine distribution is, in good approximation, rotation-symmetrical to the surface normal of the object plane (9). The scattered light or fluorescent light is detected by a detector in the form of a photo detector, such as an avalanche photodiode (APD). These APDs have characteristic surface geometries of a few 0.1 mm to a few millimeters. This means that these, due to the small size thereof, are installed at a small distance, that is, just a few millimeters, for example less than 1 cm according to the invention, in particular less than 7 mm, further in particular less than 5 mm, away from the object plane (9). In this way, high light efficiency of scattered light or fluorescent light is ensured. The installation angle of the APD relative to the direction of incidence of the sub-beams (7) is the only boundary condition and must ensure that the APD is not located in the beam path of the sub-beams (7). As a result, the APD can advantageously be positioned at an angle of at least 5°, and more preferably of less than 10°, relative to the surface normal of the object plane (9). Since the radiation characteristics of the illuminated points of the object plane (9) are rotation-symmetrical about the surface normal of the plane (9), it is also possible to install the APD rotation-symmetrically about the axis of the radiation characteristics. Since the photo detector is not located in the axis of the sub-beams (7), it is also possible to provide a separate optical focusing device for the detector, for example in the form of a lens.

The following aspects also form part of the invention and can each represent inventions either alone or in combination with the features of the claims.

Aspect 1. An analysis device for one or more samples, comprising an illumination device for illuminating samples or sections of samples in sequence by way of an illuminating beam, and comprising a detection device for detecting secondary radiation that emanates, as a result of the illumination, from the illuminated sample or the illuminated section in the form of a secondary beam in the direction of the detection device, wherein the illumination device comprises a deflection device, in particular a regulatable or controllable 2D scanner, and further in particular a 2D MEMS scanner, for deflecting the illuminating beam to the sample or samples, and wherein a parabolic mirror is arranged in the light path of the illuminating beam and/or in the light path of the secondary beam.
Aspect 2. The analysis device according to aspect 1, wherein the illuminating beam and the secondary beam are reflected at the same parabolic mirror.
Aspect 3. The analysis device according to aspect 1 or 2, wherein the illuminating beam is a laser beam.
Aspect 4. The analysis device according to aspect 1, 2 or 3, wherein the deflection device is arranged on the axis of symmetry of a parabolic mirror.
Aspect 5. The analysis device according to aspect 4, wherein the deflection device (2), in particular the point of the deflection device at which all possible deflected illuminating beams converge, and further in particular the intersecting point of two pivot axes of the mirror of the deflection device, is arranged in the focal point of a parabolic mirror or in the immediate vicinity of the focal point.
Aspect 6. The analysis device according to aspect 1, 2, 3 or 4, wherein a detector of the detection device is arranged in the focal point of a parabolic mirror or in the immediate vicinity of the focal point.
Aspect 7. The analysis device according to aspect 1 or one that follows, wherein the detector detects an intensity integral over a sensor surface with respect to the radiation impinging thereon.
Aspect 8. The analysis device according to aspect 1 or one that follows, wherein an optical filter is arranged in the light path of the secondary beam.
Aspect 9. The analysis device according to aspect 8, wherein the optical filter only allows fluorescent light emitted by the sample to pass to the detector.
Aspect 10. The analysis device according to aspect 8, wherein the optical filter only allows the wavelength range of the illuminating beam to pass to the detector.
Aspect 11. The analysis device according to aspect 1 or one that follows, wherein a beam shaping lens system is provided for shaping the illuminating beam.
Aspect 12. The analysis device according to aspect 1 or one that follows, wherein, with respect to each location which can be illuminated by the illuminating beam and at which a sample or a section of a sample can be arranged, a correction factor of the illumination intensity is established which takes the angle into consideration at which the illuminating beam reaches a sample surface, and in particular also the curvature of the parabolic mirror at the point at which the illuminating beam is reflected thereat.
Aspect 13. The analysis device according to aspect 1 or one that follows, wherein, with respect to each location which can be illuminated by the illuminating beam and at which a sample or a section of a sample can be arranged, a correction factor of the detection sensitivity is established which takes the angle into consideration at which the secondary beam detected by the detector emanates from the sample surface, and in particular the curvature of a parabolic mirror at the point at which the secondary beam is reflected thereat.

It is the object of the above aspects, among other things, to provide a configuration for an analysis device which allows the measurement in multiple sample sections or on multiple samples, while allowing efficient beam guidance during the illumination of the sample and the detection of secondary radiation emanating from the sample.

All of the above aspects can also be combined with the subjects of the accompanying claims with respect to an analysis device.

Accordingly, the aspects relate to an analysis device for one or more samples, comprising an illumination device for illuminating samples or sections of samples in sequence by way of an illuminating beam, and comprising a detection device for detecting secondary radiation that emanates, as a result of the illumination, from the illuminated sample or the illuminated section in the form of a secondary beam in the direction of the detection device, wherein the illumination device comprises a deflection device, in particular a controllable or regulatable 2D scanner, and further in particular a MEMS scanner, for deflecting the illuminating beam to the sample or samples, and wherein a parabolic mirror is arranged in the light path of the illuminating beam and/or in the light path of the secondary beam.

In this way, an illuminating beam can be directed onto different sections of a sample or of multiple samples by way of the deflection device, and a secondary beam emanating from the sample toward the illumination can be detected. As a result, different samples or sample sections, which are located on a shared sample carrier, for example, can be analyzed in very rapid succession. By using parabolic mirrors, it is possible to establish the optical path of the illuminating beam in a way that can be monitored and controlled particularly easily, in particular in connection with a deflection device. In this way, dispersive elements (such as lenses) can essentially be dispensed with. On the detection side, for example, it is possible to measure laser-induced fluorescence, absorption of the irradiated light or scattered light intensity. For the different types of radiation to be detected modified configurations are necessary in each case.

The deflection device makes it possible to illuminate a large number of samples or a larger sample surface by scanning using an illuminating beam. For this purpose, a migrating light spot or a spot consecutively illuminating different pixels can be used, which consecutively scans samples or sample sections in a controlled manner by way of the controlled deflection device. Since the position of the deflection device is very precisely defined and establishable, in particular when it is a 2D scanner, and particularly when it is a MEMS scanner, it is precisely known for each time or unit of time which section of a sample or which sample is in the process of being illuminated by the illuminating beam, so that it is also possible to assign the signal response of a sample or of a sample section detected on the detection side by the detection device without a doubt. In this way, it is also possible to add signal intensities across the sub-areas of a sample or to detect intensity distributions based on the respective illuminated sample location, for example so as to yield an integrated signal curve across the overall surface area or sub-areas of a sample. It is thus also possible to compare intensities of the secondary radiation of different samples to one another so that, for example, scatter intensities, transmission intensities or fluorescence intensities of different samples, and also the changes thereof over time, can be compared to one another.

The detection device does not require a spatially resolving radiation detector for this purpose, but a sensor that detects an overall radiation intensity on the surface thereof is sufficient. The resolution with respect to the sample surface takes place by the selective illumination by the illuminating beam, if such a resolution is necessary.

The use of a parabolic mirror, which is able to focus radiation signals from a larger surface area of the sample holder, that is, also of multiple samples, onto a stationary detector with relatively little distortions, can also be advantageous on the detection side in the region of the detection device, as well as in the optical path of the illuminating beam in front of the sample/samples.

A specific embodiment can provide that the illuminating beam and the secondary beam are reflected at the same parabolic mirror. Such a configuration is possible, for example, when the detection device is configured to detect radiation reflected from the sample, or fluorescent radiation emanating from the sample, in the same direction from which the illuminating beam comes. The parabolic mirror can then be arranged in front of the sample and be used both to reflect the illuminating beam toward the sample and to focus the secondary beams onto a sensor of the detection device.

So as to render both the intensity and the beam guidance particularly easily controllable and monitorable, and moreover to be able to design the wavelength range of the illuminating beam to meet the requirements of fluorescence effects, for example, it may further be provided that the illuminating beam is a laser beam. In this way, it is also easily possible to achieve the desired intensity, or the intensity that may be required in an individual case, of the illuminating beam.

A further embodiment can provide that the deflection device is arranged on the axis of symmetry of a parabolic mirror. Such an arrangement of the deflection device achieves a symmetrical configuration by way of which the illuminating beam is able to reach and illuminate the different regions of the sample holder, that is, different samples or different sample sections situated thereon, as uniformly as possible. Remaining distortions, for example in the range of larger diversion angles of the deflection device, can be taken into consideration computationally in the evaluation of the detected signals.

It can further be provided that the deflection device, in particular the point of the deflection device at which all possible deflected illuminating beams converge, and further in particular the intersecting point of two pivot axes of the mirror or of mirrors of the deflection device, is arranged in the focal point of a parabolic mirror or in the immediate vicinity of the focal point. As a result of such a configuration, it can be ensured that the illuminating beam emanates from the focal point of the parabolic mirror independently of the deflection angle set by the deflection device, and is thus radiated, after reflection in the mirror, in any case parallel to the axis of symmetry of the parabolic mirror. It is thus possible to achieve, within a wide range, that different samples located next to one another on a sample holder, or different sections of a sample, are illuminated under the same angle of incidence by the illuminating beam.

Furthermore, it may be provided that the axis of symmetry of the parabolic mirror extends parallel to the surface normal of a sample plane in which the one sample is arranged or different samples are arranged. In this case, the sample is illuminated, or different samples arranged next to one another are illuminated consecutively, but in each case perpendicularly to the sample surface.

Another embodiment can provide that a detector of the detection device is arranged in the focal point of a parabolic mirror or in the immediate vicinity of the focal point. In such an arrangement, beams incident upon the parabolic mirror in parallel are each reflected onto the detector of the detection device. From the radiation characteristic of every single sample or every sample section, radiation that is emitted by the individual samples or sample sections under a defined angle of the lobe is thus directed onto the detector. The solid angle section of the secondary radiation emanating from the samples and impinging upon the detector is thus the same for all measured sample sections/samples. This avoids distortions during the comparison of the signal responses of different samples, which can be created in that different emission solid angle components from different samples are detected.

If the detection device is not arranged directly in the focal point, but in the vicinity thereof, this goal is achieved at least approximately. Such a configuration can be useful, for example, when the deflection device is located directly in the focal point of the parabolic mirror and, consequently, there is no room there for the detector. However, conversely, it may also be provided that the detector is located directly in the focal point, and the deflection device is shifted out of the focal point. In both instances, the displacement away from the focal point should be kept to a minimum, both for the detector and for the deflection device, that is, optimally less than 1 cm, and advantageously less than 5 mm.

Another embodiment can provide that an optical filter is arranged in the light path of the secondary beam. In this way, the detected radiation impinging upon the sensor is to be selected and ambient light is to be separated out, wherein the sensor does not require any spatial resolution, but detects an overall intensity of the radiation impinging thereupon. Technically, the sensor can nonetheless be composed of multiple light-sensitive or radiation-sensitive sensors, the signals of which are directly added or integrated.

Furthermore, it may be provided that the optical filter only allows the wavelength range of the illuminating beam to pass to the detector. In this way, it can be ensured, for example, that only the portion of the light of the sample which is directly reflected by the illuminating beam, or a portion of the light that is allowed to pass through the sample, is detected. The optical filter then has to be configured so as to allow the wavelength ranges of the illuminating beam to pass.

However, it may also be provided that the optical filter only allows the wavelength range or a portion of the wavelength range of the fluorescent radiation to pass to the detector. In this case, the filter is designed for the expected fluorescent radiation and blocks foreign interfering light so that, for example, the signal to noise ratio is improved or, for example, specific wavelength ranges can be examined separately.

A further embodiment can provide that, with respect to each location which can be illuminated by the illuminating beam and at which a sample or a section of a sample can be arranged, a correction factor of the illumination intensity is established, which takes the angle into consideration at which the illuminating beam reaches a sample surface, and in particular also the curvature of the parabolic mirror at the point at which the illuminating beam is reflected thereat.

Moreover, a beam shaping lens system can be provided in the path of the illuminating beam. Such a beam shaping lens system usually comprises one or more lenses, which set the beam diameter and/or the beam divergence.

Even though the described configuration already achieves a high degree of uniformity in the illumination of different samples and a high degree of consistency in the sensitivity of the detection of the secondary radiation, it may be necessary to carry out corrective calculations in the evaluation of signals stemming from different samples or sample sections. Corresponding correction factors are essentially or even exclusively dependent on the location at which the respective sample or the sample section is situated during the illumination and the detection of the secondary radiation. A matrix of correction values can thus be assigned to the analysis device, which take the corrections into consideration in the calculation of the illumination intensity arriving at the sample site and/or take corrections into consideration in the detection of secondary radiation stemming from the sample site. Such a matrix can be stored in an evaluation device and be taken into consideration in the evaluation of the measurements.

For this purpose, it can be specifically provided that, with respect to each location which can be illuminated by the illuminating beam and at which a sample or a section of a sample can be arranged, a correction factor of the detection sensitivity is established, which takes the angle into consideration at which the secondary beam detected by the detector emanates from the sample surface, and in particular the curvature of a parabolic mirror at the point at which the secondary beam is reflected thereat.

1. An image generation device, comprising a laser light source, a mirror array including two parabolic mirrors, via which a scanning light beam generated by the laser light source is directed onto a sample surface, a deflection device, which can be controlled such that the scanning light beam scans points of the sample surface in a targeted manner, and a detector, which detects radiation emanating from a scanned point of the sample surface.

2. The image generation device according to claim 1, wherein the deflection device comprises a 2D MEMS scanner.

3. The image generation device according to claim 1, wherein the deflection device is arranged in the focal point of the first parabolic mirror passed first by the scanning light beam.

4. The image generation device according to claim 1, wherein the deflection device comprises an angle setting element.

5. The image generation device according to claim 1, wherein the sample surface is arranged in the direction of the scanning light beam between 1 mm and 5 mm in front of or behind the focal point of the second parabolic mirror which the scanning light beam passes after the first parabolic mirror.

6. The image generation device according to claim 1, wherein the axes of symmetry of the first and second parabolic mirrors extend parallel to one another.

7. The image generation device according to claim 1, wherein the detector comprises a sensor for radiation detection, which detects a surface-integral radiant intensity.

8. The image generation device according to claim 7, wherein the detector comprises an avalanche diode.

9. The image generation device according to claim 1, wherein the two parabolic mirrors have the same shape and size.

10. The image generation device according to claim 1, wherein the two parabolic mirrors have different sizes and/or shape coefficients.

11. The image generation device according to claim 1, wherein the distance between the sample surface and the focal point of the second parabolic mirror is capable of being set.

12. The image generation device according to claim 1, wherein the laser light source and the deflection angles of the deflection device are capable of being controlled by a control unit in such a way that defined points of the sample surface are irradiated at definable points in time, and a radiant intensity emanating from the point which is detected by the detector is assigned to each irradiated point.

13. A method for operating an image generation device comprising a laser light source, a mirror array including two parabolic mirrors, via which a scanning light beam-generated by the laser light source is directed onto a sample surface, a deflection device that can be controlled such that the scanning light beam scans points of the sample surface in a targeted manner, and a detector, which detects radiation emanating from a scanned point of the sample surface, the method comprising:
directing the scanning light beam, prior to or after scanning of the sample surface, onto a sub-area of the sample surface in a static setting of the deflection device and, in this setting, carrying out a spectroscopic examination of the radiation emitted by the sub-area.
